(19) United States
(12) Patent Application Publication
(10) Pub. No.: US 2020/0401667 A1
(43) Pub. Date: Dec. 24, 2020

(54) SYSTEMS AND METHODS FOR CONTENT PROVISIONING

(71) Applicant: Facebook, Inc., Menlo Park, CA (US)

(72) Inventors: Bangaly Kaba, Redwood City, CA (US); Sourav Chatterji, Fremont, CA (US); Chi-Ted Edward Li, Burlingame, CA (US); Daniel Kim, San Francisco, CA (US)

(21) Appl. No.: 15/963,730

(22) Filed: Apr. 26, 2018

(51) Int. Cl. G06F 17/30; G06N 99/00

(52) U.S. Cl. CPC G06F 17/30867; G06N 99/005; G06F 17/30554; G06F 17/3053

(57) ABSTRACT

Systems, methods, and non-transitory computer-readable media can determine an interaction flow for interacting with a given user, the interaction flow including a set of candidate components that are eligible to be dynamically presented to the user. A set of features associated with the user can be determined. At least one first component from the set of candidate components can be determined based at least in part on the set of features associated with the user. The at least one first component can be provided for presentation to the user.

### FIELD OF THE INVENTION

The present technology relates to the field of content provisioning. More particularly, the present technology relates to techniques for customizing the provisioning of content.

### BACKGROUND

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

### SUMMARY

Various embodiments of the present disclosure can include systems, methods, and non-transitory computer readable media configured to determine an interaction flow for interacting with a given user, the interaction flow including a set of candidate components that are eligible to be dynamically presented to the user. A set of features associated with the user can be determined. At least one first component from the set of candidate components can be determined based at least in part on the set of features associated with the user. The at least one first component can be provided for presentation to the user.

In an embodiment, the at least one first component is determined based at least in part on outputs generated by one or more machine learning models.

In an embodiment, the one or more machine learning models are trained to determine components to be presented to the user based at least in part on the set of features associated with the user.

In an embodiment, the one or more machine learning models are trained to predict an amount of value gained when the user converts on the at least one first component.

In an embodiment, the systems, methods, and non-transitory computer readable media are configured to determine respective scores for each component in the set of components, wherein the scores are determined based at least in part on outputs generated by the one or more machine learning models and determine that a score for the at least one first component exceeds respective scores generated for the remaining set of candidate components.

In an embodiment, the systems, methods, and non-transitory computer readable media are configured to determine a likelihood of the user converting on the at least one first component based at least in part on a first machine learning model; determine an amount of value gained when the user converts on the at least one first component based at least in part on a second machine learning model; and determine the score for the at least one first component based at least in part on (i) the likelihood of the user converting on the at least one first component and (ii) the amount of value gained.

In an embodiment, the amount of value gained is determined based at least in part on an objective function used to train the second machine learning model.

In an embodiment, the objective function maximizes user retention.

In an embodiment, the objective function maximizes activation of a given site feature.

In an embodiment, the one or more features associated with the user include one or more of: a geographic location in which the user resides, demographic data describing the user, a type of computing device operated by the user, a status of a network being used by the computing device, or a subscriber identification module (SIM) associated with the user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example of a dynamic presentation module, according to an embodiment of the present disclosure.

FIG. 3A illustrates an example of a conversion prediction module, according to an embodiment of the present disclosure.

FIG. 3B illustrates an example of a value prediction module, according to an embodiment of the present disclosure.

FIGS. 4A-4B illustrate example diagrams, according to various embodiments of the present disclosure.

FIG. 5 illustrates an example process, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Content Provisioning

Users are often engaged using interaction flows. In general, an interaction flow can include a set of steps that a user completes to perform some action. Further, the steps can be provided to the user based on some pre-defined sequence (or ordering). For example, users may be shown interfaces from a set of interfaces as part of a new user sign-up process. In this example, a new user may sign up for an account when accessing a software-based service provider. During the sign-up process, the service provider can sequentially present interfaces based on some pre-defined ordering. For example, the service provider can present a first interface which provides options for creating a username and password. Once the user creates a username and password, the service provider can present a second interface which provides options for uploading a profile picture to be associated with the user account. Once the user uploads a profile picture (or declines to upload a profile picture), the service provider can present a third interface which provides options for downloading and installing an optional software application on a computing device being operated by the user. However, there may be instances when presenting information based on a rigid, pre-defined ordering degrades the overall user experience. In the foregoing example, users residing in one country may prefer to download and install the optional software application whereas users residing in another country may prefer to rely on web-based access to the service provider. In such instances, presenting the third interface, which provides options for installing the software application, to users residing in the different country may negatively affect the user experience. Accordingly, having the ability to customize interaction flows to accommodate varied user preferences in real-time can drastically improve the overall user experience. Conventional approaches, however, are generally not capable of performing such customization. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, an interaction flow that includes a set of steps can be discretized into a set of components. For example, a new user sign-up process can include a set of interfaces, as described above. In this example, each interface can correspond to a component. For example, a first interface that provides options for creating a username and password can be modularized into a first component. A second interface that provides options for uploading a profile picture to be associated with the user account can be modularized into a second component. A third interface that provides options for downloading and installing an optional software application can be modularized into a third component. In some embodiments, the order in which such components are presented to a user can vary based on various features associated with the user (e.g., user demographic attributes, place of residence, device type, etc.). For example, a first user associated with a first set of features may be presented with the first component followed by the second component. In contrast, a second user having a second set of features may be presented with the first component, the third component, and then the second component. In various embodiments, components to be presented can be determined based on outputs generated by one or more trained machine learning models. For example, in some embodiments, a first machine learning model (e.g., a conversion prediction model) can be trained to predict a likelihood of a user converting on (or completing) a given component. For example, the first machine learning model can predict a likelihood of the first user converting on the first component based on features associated with the first user. In some embodiments, a second machine learning model (e.g., a value prediction model) can be trained to determine an amount of value gained when the first user converts on the first component. For example, the second machine learning model may predict an increase in overall user retention if the first user converts on the first component. In this example, outputs from the first machine learning model and the second machine learning model can be used to determine whether a given component should or should not be presented to the first user. The outputs from the first machine learning model and the second machine learning model can also modify an order in which a given component is presented if presented at all. Depending on the implementation, the first machine learning model and the second machine learning model may be used either independently or in combination with one another. For example, in some embodiments, respective outputs from the first machine learning model and the second machine learning model can be determined independently by each model. In other embodiments, an output determined by a model may be based in part on an output determined by another model. For example, an output from the second machine learning model may be determined based in part on an output generated by the first machine learning model. Many variations are possible. In general, the approaches described herein may be adapted to customize the presentation of any interaction flow (e.g., UX flows) such as an interaction flow for modifying account settings or an interaction flow for adding social connections, for example. Many variations are possible. More details relating to the disclosed technology are provided below.

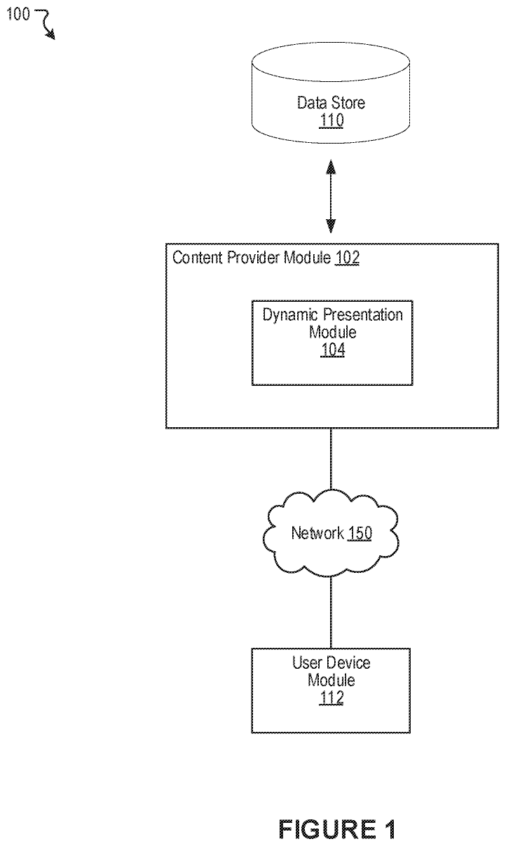

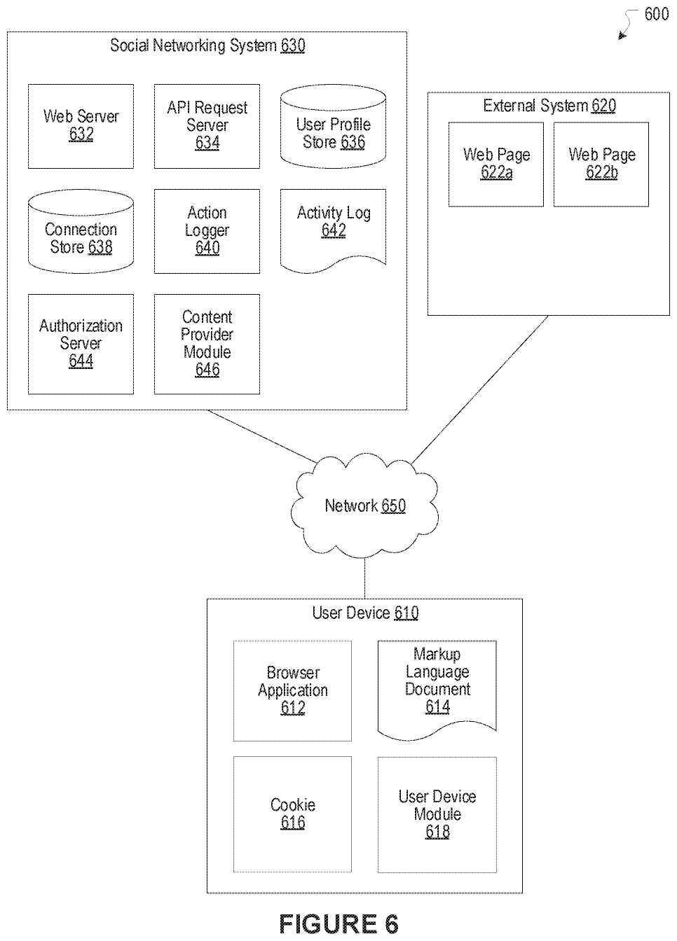

FIG. 1 illustrates an example system 100 including an example content provider module 102, according to an embodiment of the present disclosure. As shown in the example of FIG. 1, the content provider module 102 can include a dynamic presentation module 104. In some instances, the example system 100 can include at least one data store 110. A user device module 112 can interact with the content provider module 102 over one or more networks 150 (e.g., the Internet, a local area network, a cellular network, etc.). In some embodiments, the user device module 112 can be implemented in a software application (e.g., social networking application) running on a computing device being operated by a given user. In some embodiments, the user is a member of a social network (e.g., the social networking system 630 of FIG. 6). The components (e.g., modules, elements, etc.) shown in this figure and all figures herein are exemplary only, and other implementations may include additional, fewer, integrated, or different components. Some components may not be shown so as not to obscure relevant details.

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 and/or the user device module 112 or at least a portion thereof can be implemented as or within an application (e.g., app), a program, or an applet, etc., running on a user computing device or a client computing system, such as the user device 610 of FIG. 6. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6. The content provider module 102 can be implemented as or within a dedicated application (e.g., app), a program, or an applet running on a user computing device or client computing system. The application incorporating or implementing instructions for performing some, or all, functionality of the content provider module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In some embodiments, the content provider module 102 can be configured to communicate and/or operate with the at least one data store 110 in the example system 100. In various embodiments, the at least one data store 110 can store data relevant to the function and operation of the content provider module 102. In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data. It should be appreciated that there can be many variations or other possibilities.

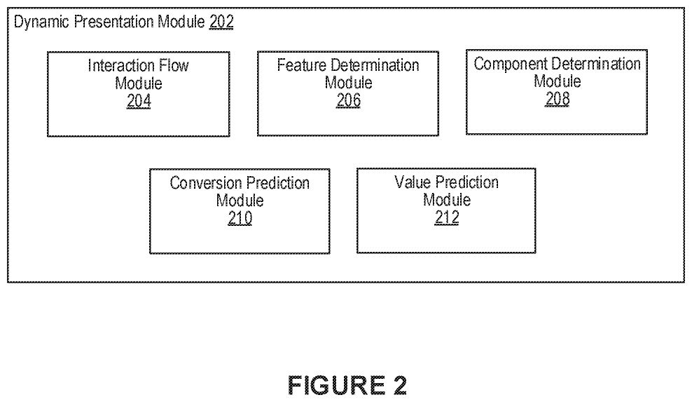

The dynamic presentation module 104 can be configured to customize interaction flows based on various attributes associated with users. More details regarding the dynamic presentation module 104 will be provided below with reference to FIG. 2.

FIG. 2 illustrates an example of a dynamic presentation module 202, according to an embodiment of the present disclosure. In some embodiments, the dynamic presentation module 104 of FIG. 1 can be implemented as the dynamic presentation module 202. As shown in FIG. 2, the dynamic presentation module 202 can include an interaction flow module 204, a feature determination module 206, a component determination module 208, a conversion prediction module 210, and a value prediction module 212.

The interaction flow module 204 can determine when a given user is accessing an interaction flow, for example, through a computing system (e.g., the social networking system 630 of FIG. 6). As mentioned, in various embodiments, an interaction flow can include a set of steps (or interfaces) that a user completes to perform some action. Further, the steps can be provided to the user based on some pre-defined sequence (or ordering). For example, as mentioned, an interaction flow corresponding to a new user sign-up process may include a number of interfaces that each provide different content and/or options for interacting with the computing system. In this example, the interaction flow can be invoked when the user selects an option to sign-up for a new account. In various embodiments, the interaction flow module 204 can divide the steps of the interaction flow into components. For example, the new user sign-up process can include a set of interfaces. In this example, each interface can correspond to an individual component. For example, a first interface that provides options for creating a username and password can be modularized into a first component. Similarly, a second interface that provides options for uploading a profile picture to be associated with the user account can be modularized into a second component. Further, a third interface that provides options for downloading and installing an optional software application can be modularized into a third component. Many variations are possible.

In various embodiments, components of the interactive flow can be presented dynamically based on various features. For example, a user associated with one set of attributes may be shown different components from the interactive flow than another user associated with a different set of attributes. In various embodiments, the feature determination module 206 can determine respective features associated with users. Such features can include user demographic attributes (e.g., age, gender, etc.), geographic location(s) and/or legal jurisdictions in which the user resides (e.g., city, state, country, etc.), a type of computing device used by the user, a type of network used by the computing device (e.g., cellular, WiFi, etc.), network status, and a subscriber identification module (SIM) associated with the user, to name some examples. Many variations are possible.

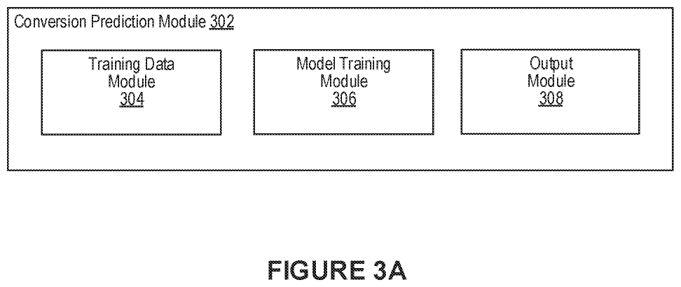

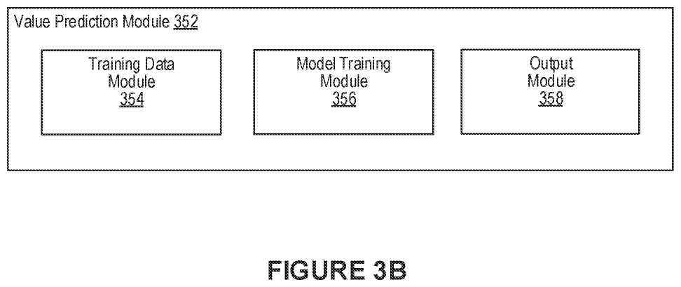

The component determination module 208 can be configured to dynamically determine components to be shown to a given user based on a set of features associated with the user. For example, the interaction flow may include a number of candidate components that are eligible to be shown to a user. When the interaction flow is accessed, the component determination module 208 can determine respective scores for each of the candidate components. The component having the best (or highest) score is then presented to the user. Once the user completes (or converts on) the presented component, the component determination module 208 can again determine respective scores for each of the remaining candidate components and then present the next component with the best score. This dynamic presentation of components can continue until the interaction flow is determined to be complete. Many variations are possible. In some embodiments, component scores can be determined based on outputs generated by the conversion prediction module 210 and the value prediction module 212. For example, in some embodiments, the conversion prediction module 210 can output a likelihood of a user converting on (or completing) a given component based on various features associated with the user. In general, a component may be deemed completed (or converted on) by a user when the user performs any actions requested by the component. For example, a component corresponding to an interface that asks the user to input a name and email address can be deemed completed once the user inputs a name and email address through the interface. Many variations are possible. In some embodiments, the value prediction module 212 can output an amount of value gained if a user completes (or converts on) a given component. In various embodiments, the component determination module 208 can combine outputs generated by the conversion prediction module 210 and the value prediction module 212 to determine a score for a given component. For example, in some embodiments, the score can be determined by multiplying the output generated by the conversion prediction module 210 and the output generated by the value prediction module 212. Many variations are possible. The component determination module 208, therefore, is able to determine which components are to be shown to a given user and when to show a given component. As a result, different components of an interaction flow can be shown to different users at different times. For example, a user residing in one country may be presented one set of components from an interaction flow while another user residing in another country may be presented another set of components from the same interaction flow. Many variations are possible. For example, in some embodiments, components may be presented through different surfaces. For example, a component may be presented as a page, as an interstitial page (e.g., pages that come before or after a page), as a quick promotion, or as a pop-up. In such embodiments, the conversion prediction module 302 can also be trained to predict a surface through which a given component should be presented. More details regarding the conversion prediction module 210 will be provided below with reference to FIG. 3A. More details regarding the value prediction module 212 will be provided below with reference to FIG. 3B.

FIG. 3A illustrates an example of a conversion prediction module 302, according to an embodiment of the present disclosure. In some embodiments, the conversion prediction module 210 of FIG. 2 can be implemented as the conversion prediction module 302. As shown in FIG. 3A, the conversion prediction module 302 can include a training data module 304, a model training module 306, and an output module 308.

The training data module 304 can be configured to generate training data for training a model to predict a likelihood of a given user converting on (or completing) a given component of an interaction flow based on a set of features associated with the user. In general, the training data module 304 can generate the training data from historical information describing various user activity while interacting with components of the interaction flow for which the model is being trained. For example, the historical information can indicate, for various users, a set of features associated with the user, which components of the interaction flow were presented to the user, the order in which the components were presented, which surfaces those components were presented through, and which presented components of the interaction flow were completed (or converted) by the user. In various embodiments, the set of features associated with the user can also include demographic attributes (e.g., age, gender, etc.), geographic location(s) and/or legal jurisdictions in which the user resides (e.g., city, state, country, etc.), a type of computing device used by the user, a type of network used by the computing device (e.g., cellular, WiFi, etc.), network status, and a subscriber identification module (SIM) associated with the user, to name some examples. Many variations are possible. In various embodiments, the model can be trained to interpret these myriad features when outputting a likelihood of the user completing a given component of the interaction flow.

The model training module 306 can be configured to train a model for predicting respective likelihoods of users completing various components using the training data generated by the training data module 304. In various embodiments, the model training module 306 can train the model using generally known machine learning techniques. For example, in some embodiments, the machine learning model may be a regression model (e.g., non-linear regression model). Many variations are possible.

Once the model is trained, the output module 308 can be configured to output a likelihood of a given user completing a given component of the interaction flow based on the set of features associated with the user. Again, many variations are possible.

FIG. 3B illustrates an example of a value prediction module 352, according to an embodiment of the present disclosure. In some embodiments, the value prediction module 212 of FIG. 2 can be implemented as the value prediction module 352. As shown in FIG. 3B, the value prediction module 352 can include a training data module 354, a model training module 356, and an output module 358.

The training data module 354 can be configured to generate training data for training a model to predict an amount of value gained when a given user completes a given component. In some embodiments, the model can be trained based on an objective function. For example, the model may predict an increase in overall user retention if a user completes a given component. In general, the training data module 354 can generate the training data from historical information describing various user activity while interacting with components of the interaction flow for which the model is being trained as described above. For example, the historical information can indicate, for various users, a set of features associated with the user, which components of the interaction flow were completed (or converted) by the user, and a respective amount of value that was gained from completion of any given component. Many variations are possible.

The model training module 356 can be configured to train a model for predicting an amount of value gained using the training data generated by the training data module 354. In various embodiments, the model training module 356 can train the model using generally known machine learning techniques. For example, the model can be trained based on one or more objective functions that seek to maximize or minimize some specified metric. Many variations are possible.

Once the model is trained, the output module 358 can be configured to predict an amount of value gained when a given user completes a given component. Again, many variations are possible.

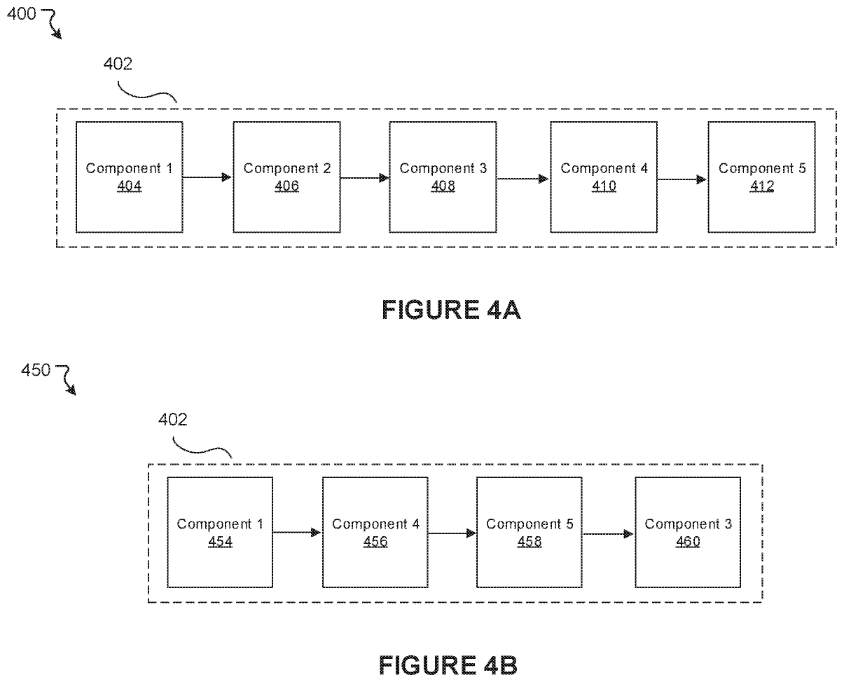

FIG. 4A illustrates an example diagram 400 of an interaction flow 402. In this example, the interaction flow 402 includes a set of components that are presented to users based on a pre-defined sequence. For example, under conventional approaches, at block 404, a user accessing the interaction flow 402 would be presented a first component of the interaction flow 402. Once the user completes the first component, at block 406, the user would be presented a second component of the interaction flow 402. Once the user completes the second component, at block 408, the user would be presented a third component of the interaction flow 402. Once the user completes the third component, at block 410, the user would be presented a fourth component of the interaction flow 402. Finally, once the user completes the fourth component, at block 412, the user would be presented a fifth component of the interaction flow 402.

In various embodiments, components of the interaction flow 402 can be presented dynamically as illustrated in the example diagram 450 of FIG. 4B. For example, in some embodiments, components of the interaction flow 402 can be scored based on outputs generated by one or more machine learning models, as described above. The components can then be presented based on their respective scores. For example, at block 454, a user accessing the interaction flow 402 would be presented the first component of the interaction flow 402. Once the user completes the first component, another component from the interaction flow 402 can be determined and presented based on outputs generated by the one or more machine learning models. In this example, at block 456, a determination is made that the fourth component of the interaction flow 402 has the best (or highest) score and, therefore, should be shown next to the user. Similarly, once the user completes the fourth component, at block 458, a determination is made that the fifth component of the interaction flow 402 has the best (or highest) score and, therefore, should be shown next to the user. Finally, once the user completes the fifth component, at block 460, a determination is made that the third component of the interaction flow 402 has the best (or highest) score and, therefore, should be shown next to the user. As a result, different users can be shown different portions (or components) of an interaction flow based on features associated with those users. Thus, users can be shown different components of the same interaction flow based on their features. Many variations are possible.

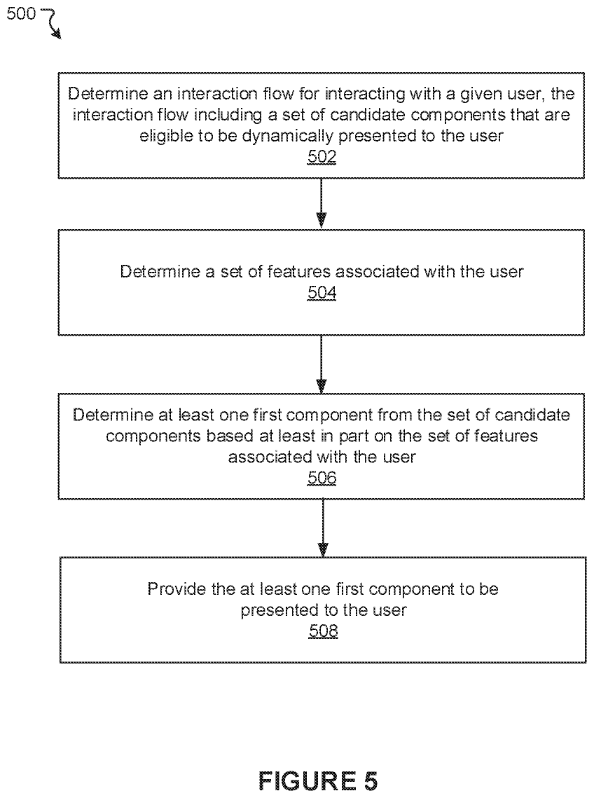

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, an interaction flow for interacting with a given user is determined. The interaction flow can include a set of candidate components that are eligible to be dynamically presented to the user. At block 504, a set of features associated with the user are determined. At block 506, at least one first component from the set of candidate components is determined based at least in part on the set of features associated with the user. At block 508, the at least one first component is provided for presentation to the user.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. The content provider module 646 may also be implemented, in whole or in part, in the user device 610. The user device module 618 can, for example, be implemented as the user device module 112 of FIG. 1. As discussed previously, it should be appreciated that there can be many variations or other possibilities.

### Hardware Implementation

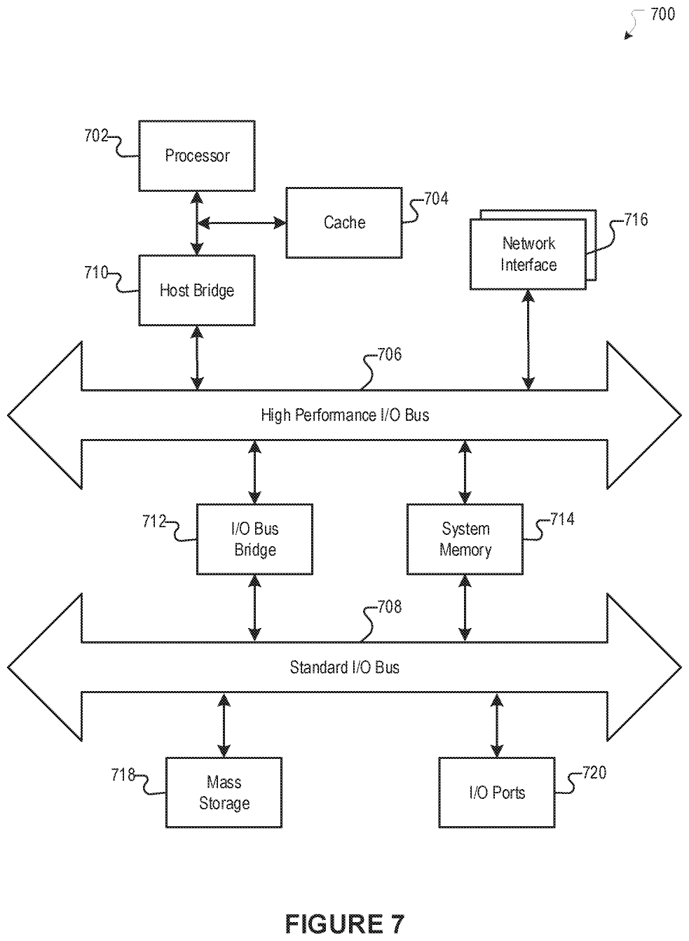

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, an interaction flow for interacting with a given user, the interaction flow including a set of candidate components that are eligible to be dynamically presented to the user;
determining, by the computing system, a set of features associated with the user;
determining, by the computing system, at least one first component from the set of candidate components based at least in part on the set of features associated with the user; and
providing, by the computing system, the at least one first component to be presented to the user.

2. The computer-implemented method of claim 1, wherein the at least one first component is determined based at least in part on outputs generated by one or more machine learning models.

3. The computer-implemented method of claim 2, wherein the one or more machine learning models are trained to determine components to be presented to the user based at least in part on the set of features associated with the user.

4. The computer-implemented method of claim 2, wherein the one or more machine learning models are trained to predict an amount of value gained when the user converts on the at least one first component.

5. The computer-implemented method of claim 2, wherein determining the at least one first component from the set of candidate components further comprises:
determining, by the computing system, respective scores for each component in the set of components, wherein the scores are determined based at least in part on outputs generated by the one or more machine learning models; and
determining, by the computing system, that a score for the at least one first component exceeds respective scores generated for the remaining set of candidate components.

6. The computer-implemented method of claim 5, wherein determining the respective scores for each component in the set of components further comprises:
determining, by the computing system, a likelihood of the user converting on the at least one first component based at least in part on a first machine learning model;
determining, by the computing system, an amount of value gained when the user converts on the at least one first component based at least in part on a second machine learning model; and
determining, by the computing system, the score for the at least one first component based at least in part on (i) the likelihood of the user converting on the at least one first component and (ii) the amount of value gained.

7. The computer-implemented method of claim 6, wherein the amount of value gained is determined based at least in part on an objective function used to train the second machine learning model.

8. The computer-implemented method of claim 7, wherein the objective function maximizes user retention.

9. The computer-implemented method of claim 7, wherein the objective function maximizes activation of a site feature.

10. The computer-implemented method of claim 1, wherein the one or more features associated with the user include one or more of: a geographic location in which the user resides, demographic data describing the user, a type of computing device operated by the user, a status of a network being used by the computing device, or a subscriber identification module (SIM) associated with the user.

11. A system comprising:
at least one processor; and
a memory storing instructions that, when executed by the at least one processor, cause the system to perform:
determining an interaction flow for interacting with a given user, the interaction flow including a set of candidate components that are eligible to be dynamically presented to the user;
determining a set of features associated with the user;
determining at least one first component from the set of candidate components based at least in part on the set of features associated with the user; and
providing the at least one first component to be presented to the user.

12. The system of claim 11, wherein the at least one first component is determined based at least in part on outputs generated by one or more machine learning models.

13. The system of claim 12, wherein the one or more machine learning models are trained to determine components to be presented to the user based at least in part on the set of features associated with the user.

14. The system of claim 12, wherein the one or more machine learning models are trained to predict an amount of value gained when the user converts on the at least one first component.

15. The system of claim 12, wherein determining the at least one first component from the set of candidate components further causes the system to perform:
determining respective scores for each component in the set of components, wherein the scores are determined based at least in part on outputs generated by the one or more machine learning models; and
determining that a score for the at least one first component exceeds respective scores generated for the remaining set of candidate components.

16. A non-transitory computer-readable storage medium including instructions that, when executed by at least one processor of a computing system, cause the computing system to perform a method comprising:
determining an interaction flow for interacting with a given user, the interaction flow including a set of candidate components that are eligible to be dynamically presented to the user;
determining a set of features associated with the user;
determining at least one first component from the set of candidate components based at least in part on the set of features associated with the user; and
providing the at least one first component to be presented to the user.

17. The non-transitory computer-readable storage medium of claim 16, wherein the at least one first component is determined based at least in part on outputs generated by one or more machine learning models.

18. The non-transitory computer-readable storage medium of claim 17, wherein the one or more machine learning models are trained to determine components to be presented to the user based at least in part on the set of features associated with the user.

19. The non-transitory computer-readable storage medium of claim 17, wherein the one or more machine learning models are trained to predict an amount of value gained when the user converts on the at least one first component.

20. The non-transitory computer-readable storage medium of claim 17, wherein determining the at least one first component from the set of candidate components further causes the system to perform:
determining respective scores for each component in the set of components, wherein the scores are determined based at least in part on outputs generated by the one or more machine learning models; and
determining that a score for the at least one first component exceeds respective scores generated for the remaining set of candidate components.
